(19) United States
(12) Patent Application Publication
(10) Pub. No.: US 2026/0331332 A1
(43) Pub. Date: Oct. 22, 2026

(54) SHIELDED SOLID ELECTRIC WIRE AND METHOD FOR MANUFACTURING SHIELDED SOLID ELECTRIC WIRE

(71) Applicant: YAZAKI CORPORATION, Tokyo (JP)

(72) Inventors: Mizuki Shirai, Susono-shi (JP); Yukito Aoyama, Susono-shi (JP); Hayato Ikeya, Susono-shi (JP); Hiroki Kondo, Susono-shi (JP)

(21) Appl. No.: 19/572,867

(22) Filed: Mar. 20, 2026

(30) Foreign Application Priority Data
Apr. 18, 2025 (JP) 2025-068583

(51) Int. Cl. H01B 7/20; H01B 1/02; H01B 7/02; H01B 7/29; H01B 13/004

(52) U.S. Cl. CPC H01B 7/20; H01B 1/02; H01B 7/0216; H01B 7/292; H01B 13/004

(57) ABSTRACT

A shielded solid electric wire includes a solid electric wire including a solid core conductor made of a conductive metal and an insulator covering the solid core conductor; a conductive metal tube provided around the solid electric wire; and an inclusion provided between the solid electric wire and the metal tube, an outermost layer of the inclusion on a metal tube side being made of a material having a friction coefficient smaller than that of the insulator.

### CROSS-REFERENCE TO RELATED APPLICATIONS

This application is based on and claims priority under 35 USC 119 from Japanese Patent Application No. 2025-068583 filed on Apr. 18, 2025, the contents of which are incorporated herein by reference.

### TECHNICAL FIELD

The present disclosure relates to a shielded solid electric wire and a method for manufacturing the shielded solid electric wire.

### BACKGROUND ART

In the related art, a shielded solid electric wire has been proposed which includes a solid core conductor having a predetermined rigidity or more, an insulating layer covering the solid core conductor, and a shield layer provided outside the insulating layer and crimped to the insulating layer (for example, see Patent Literature 1).

### CITATION LIST

### Patent Literature

Patent Literature 1: JP2023-517714A

### SUMMARY OF INVENTION

Here, the following two methods for manufacturing a shielded solid electric wire are assumed. In a first manufacturing method, a solid electric wire passes through a metal tube having an inner periphery larger than an outer periphery of an insulator, and then the metal tube is squeezed through a die. In a second manufacturing method, a plate-shaped metal plate is wrapped around a solid electric wire, a wrapped portion is welded, and then the solid electric wire is squeezed through a die.

However, in a case of adopting the first manufacturing method, as a length of the shielded solid electric wire increases, insertion work is more difficult due to friction generated when the solid electric wire passes through the metal tube, and manufacturability is no longer good. Further, even if the second manufacturing method is adopted, there is a possibility that the insulator of the solid electric wire is damaged during the welding, and it is necessary to perform welding to avoid the damage, so that manufacturability is not good.

The present disclosure has been made to solve such problems in the related art, and an object thereof is to provide a shielded solid electric wire capable of improving manufacturability, and a method for manufacturing the shielded solid electric wire.

A shielded solid electric wire according to the present disclosure includes a solid electric wire including a solid core conductor made of a conductive metal and an insulator covering the solid core conductor; a conductive metal tube provided around the solid electric wire; and an inclusion provided between the solid electric wire and the metal tube, an outermost layer of the inclusion on a metal tube side being made of a material having a friction coefficient smaller than that of the insulator.

A method for manufacturing a shielded solid electric wire according to the present disclosure includes forming a laminated body by providing, on an outer periphery of a solid electric wire including a solid core conductor made of a conductive metal and an insulator covering the solid core conductor, an inclusion formed to include a material having a friction coefficient smaller than that of the insulator such that the material serves as an outermost layer, and providing a conductive metal tube on an outer periphery of the inclusion; and compressing the formed laminated body inward from around the solid core conductor.

According to the present disclosure, it is possible to provide a shielded solid electric wire capable of improving manufacturability or a method for manufacturing the shielded solid electric wire.

### BRIEF DESCRIPTION OF DRAWINGS

FIG. 1 is a perspective view showing a shielded solid electric wire according to a first embodiment of the present disclosure;

FIG. 2 is a cross-sectional view showing the shielded solid electric wire according to the first embodiment of the present disclosure;

FIG. 3 is a process chart showing a method for manufacturing the shielded solid electric wire according to the first embodiment;

FIGS. 4A and 4B are cross-sectional views showing a shielded solid electric wire according to a second embodiment, in which FIG. 4A shows a first example, and FIG. 4B shows a second example; and

FIG. 5 is a process chart showing a method for manufacturing the shielded solid electric wire according to the second embodiment.

### DESCRIPTION OF EMBODIMENTS

Hereinafter, the present disclosure will be described with reference to preferred embodiments. The present disclosure is not limited to the following embodiments, and may be appropriately modified without departing from the gist of the present disclosure. In the embodiment to be described below, there may be portions in which illustration and description of a part of a configuration are omitted, and it is needless to say that a known or well-known technique is appropriately applied to the details of an omitted technique within a range in which no contradiction with the contents to be described below occurs.

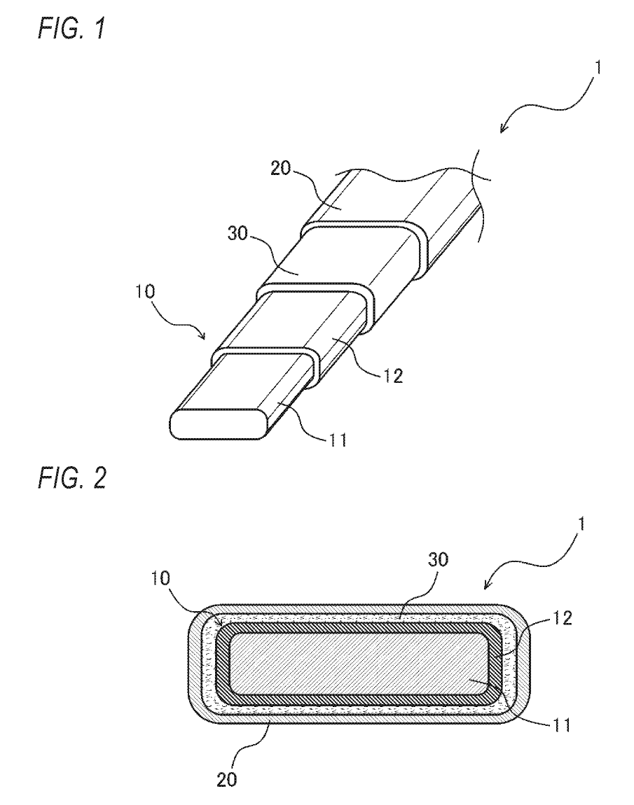

FIG. 1 is a perspective view showing a shielded solid electric wire according to a first embodiment of the present disclosure, and FIG. 2 is a cross-sectional view showing the shielded solid electric wire according to the first embodiment of the present disclosure. As shown in FIGS. 1 and 2, a shielded solid electric wire 1 according to the present embodiment includes a solid electric wire 10, a metal tube 20, and an inclusion 30.

The solid electric wire 10 is, for example, an electric wire for transmitting a large current, and includes a solid core conductor 11 and an insulator 12.

The solid core conductor 11 is a member made of a conductive metal such as copper or aluminum. The solid core conductor 11 is implemented by a busbar that is a flat metal plate. The solid core conductor 11 preferably has a predetermined rigidity and a cross-sectional area of 3 mm² or more and 300 mm² or less, more preferably 10 mm² or more, and still more preferably 100 mm² or more. In FIG. 1, the solid core conductor 11 is implemented by one metal plate, but may include a plurality of metal plates. When the solid core conductor 11 includes a plurality of metal plates, cross-sectional areas of the metal plates preferably satisfy the above condition. Further, the flat solid core conductor 11 has a substantially rectangular cross-section with rounded corners, but may have a rectangular cross-section with sharp angles without rounded corners.

The insulator 12 is an insulating member that covers the solid core conductor 11, and has a rectangular cross-section corresponding to a shape of the solid core conductor 11. Similar to the solid core conductor 11, the insulator 12 also has a substantially rectangular cross-section with rounded corners, but may have a rectangular cross-section with sharp angles.

The metal tube 20 is a conductive metal member provided around the solid electric wire 10, and exhibits a shielding function. The metal tube 20 is made of a conductive metal such as copper or aluminum. The metal tube 20 is compressed in a manufacturing step to be described later and has a tubular shape along a shape of the solid electric wire 10 having a rectangular cross-section.

The inclusion 30 is a member provided between the solid electric wire 10 and the metal tube 20. The inclusion 30 is formed by including a material (paper, a nonwoven fabric, or the like) having a friction coefficient smaller than that of the insulator 12 of the solid electric wire 10, and the material serves as an outermost layer. That is, when the inclusion 30 is formed to have a one-layer structure, the entire inclusion 30 is made of a material having a friction coefficient smaller than that of the insulator 12. Meanwhile, when the inclusion 30 is formed to have a structure of two or more layers, as long as the outermost layer of the inclusion 30 is made of a material having a friction coefficient smaller than that of the insulator 12, an inner layer other than the outermost layer may be made of another material. The inclusion 30 is attached to the insulator 12 over a length equal to or longer than at least the metal tube 20 in a longitudinal direction.

The inclusion 30 is preferably formed to include a material (for example, a resin film or a nonwoven fabric) having a Young's modulus lower than that of the insulator 12. Further, the inclusion 30 is preferably formed to include a material (for example, mica tape) having a heat-resistant temperature (a temperature at which ignition does not occur and melting does not occur) of 550°C or higher.

In such a shielded solid electric wire 1, the inclusion 30 is in contact with at least a part of an outer periphery of the insulator 12, and the metal tube 20 is in contact with at least a part of an outer periphery of the inclusion 30. It is preferable that the inclusion 30 is in contact with substantially the entire outer periphery (for example, 60% or more of the entire outer periphery) of the insulator 12 of the solid electric wire 10, and the metal tube 20 is in contact with substantially the entire outer periphery (for example, 60% or more of the entire outer periphery) of the inclusion 30. This is because, for example, when an operator grips the shielded solid electric wire 1, the inclusion 30 and the solid electric wire 10 are less likely to come off the metal tube 20. In order to realize such a contact relationship, the inclusion 30 preferably has a certain thickness and can be compressed, and for example, a nonwoven fabric is preferable.

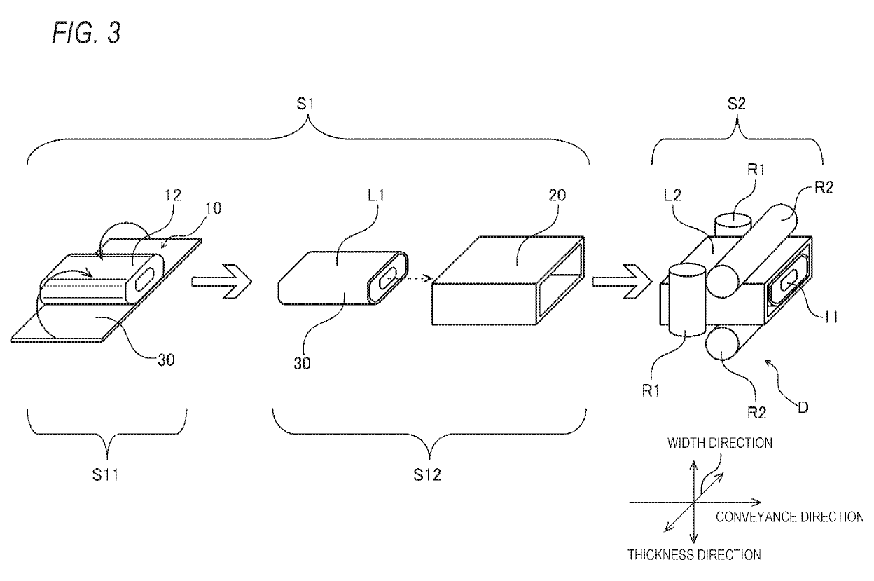

FIG. 3 is a process chart showing a method for manufacturing the shielded solid electric wire 1 according to the first embodiment. As shown in FIG. 3, the shielded solid electric wire 1 is manufactured through a laminating step S1 and a compression step S2.

The laminating step S1 is a step of providing the inclusion 30 on the outer periphery of the solid electric wire 10 and providing the conductive metal tube 20 on the outer periphery of the inclusion 30. The laminating step S1 includes a first laminating step S11 and a second laminating step S12.

The first laminating step S11 is a step of providing the inclusion 30 on the outer periphery of the solid electric wire 10. In the first laminating step S11, the tape-shaped inclusion 30 is wrapped around the solid electric wire 10, for example, in a spiral shape or longitudinally wrapped. In this step, the inclusion 30 is wrapped around the insulator 12 in at least one layer.

Further, the inclusion 30 may be provided with an adhesive layer or a bonding layer in a part or an entire region to maintain a wrapped state after the wrapping. In this step, when the inclusion 30 has a configuration of two or more layers, a material having a friction coefficient smaller than that of the insulator 12 is wrapped to face the outermost layer.

In the second laminating step S12, the metal tube 20 is provided on an outer periphery of a laminate L1 obtained in the first laminating step S11. As shown in FIG. 3, the second laminating step S12 is a step of inserting the laminate L1 into the metal tube 20 that is formed in a tubular shape in advance. Here, in the present embodiment, the inclusion 30 having a friction coefficient smaller than that of the insulator 12 is provided on the outer periphery of the solid electric wire 10. Therefore, the laminate L1 passes through the metal tube 20 more easily as compared with when the inclusion 30 is not present. As a result, workability is improved.

When the laminating step S1 is completed, the compression step S2 is performed. The compression step S2 is a step of compressing a laminated body L2 formed in the laminating step S1 from around the solid core conductor 11 inward. In the compression step S2, a die D including two first rollers R1 that can be compressed inward in a width direction and two second rollers R2 that can be compressed inward in a thickness direction is used. The laminated body L2 is compressed inward from around in the process of passing between the rollers R1 and R2. Thus, the shielded solid electric wire 1 shown in FIGS. 1 and 2 is obtained.

Here, in the example shown in FIG. 3, the laminated body L2 is compressed in the width direction first by the first rollers R1 in the compression step S2, but is not limited thereto, and may be compressed in the thickness direction first by the second rollers R2. When being first compressed in the thickness direction by the second rollers R2, the laminated body L2 first has a shape slightly bulging in the width direction. Therefore, since the laminated body L2 is compressed by the first rollers R1 later in a shape pointed in the width direction, the first rollers R1 need to exert excessive compressive forces. Therefore, in the compression step S2, as shown in FIG. 3, the laminated body L2 is preferably first compressed by the first rollers R1 in the width direction, and then compressed by the second rollers R2 in the thickness direction. Further, it is also preferable that the first rollers R1 and the second rollers R2 are provided at the same positions in a conveyance direction of the laminated body L2, and the compression is simultaneously performed in the width direction and the thickness direction. In this case, the laminated body L2 can be compressed from an entire periphery, and a possibility that the metal tube 20 of the shielded solid electric wire 1 expands in either the width direction or the thickness direction can be reduced.

In this way, according to the shielded solid electric wire 1 and the manufacturing method therefor according to the first embodiment, the inclusion 30 in which a material having a friction coefficient smaller than that of the insulator 12 is formed in the outermost layer is provided on the outer periphery of the solid electric wire 10. Therefore, the laminated body L2 can be easily inserted into the metal tube 20. Therefore, it is possible to provide the shielded solid electric wire 1 and the manufacturing method therefor capable of improving manufacturability.

When the inclusion 30 is formed to include a material having a Young's modulus lower than that of the insulator 12, elasticity of the inclusion 30 can be used to reduce stress applied to the insulator 12 during bending of the shielded solid electric wire 1.

Further, when the inclusion 30 is formed to include a material having a heat-resistant temperature of 550°C or higher, even if the insulator 12 is damaged or melted, a short circuit between the solid core conductor 11 and the metal tube 20 can be easily prevented by the inclusion 30.

Next, a second embodiment according to the present disclosure will be described. A shielded solid electric wire and a manufacturing method therefor according to the second embodiment are similar to those of the first embodiment, and are partially different. Hereinafter, the description will be made focusing on differences from the first embodiment. In the following description, the same or similar elements as those of the first embodiment are denoted by the same reference numerals, and description thereof will be omitted.

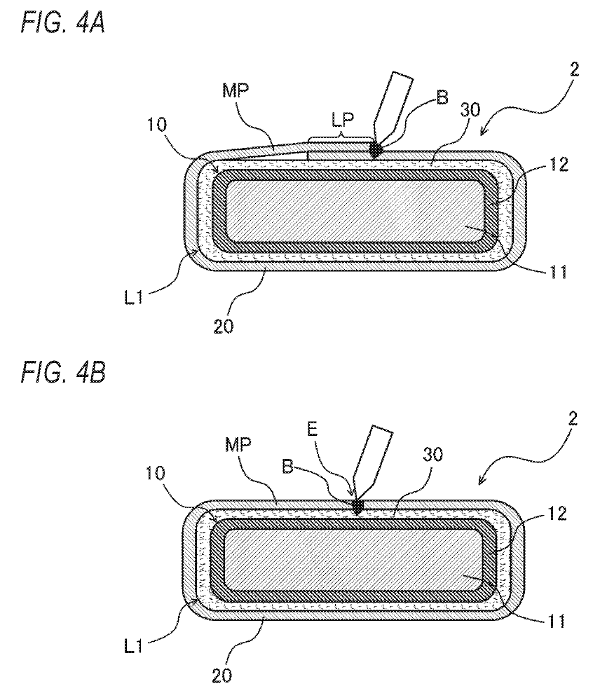

FIGS. 4A and 4B are cross-sectional views showing the shielded solid electric wire according to the second embodiment, in which FIG. 4A shows a first example and FIG. 4B shows a second example. As shown in FIGS. 4A and 4B, in a shielded solid electric wire 2 according to the second embodiment, the metal tube 20 is not formed in a tubular shape from the beginning, but is formed in a tubular shape by wrapping a metal plate MP longitudinally. That is, the metal tube 20 is formed by being wrapped around the laminate L1, which is the solid electric wire 10 provided with the inclusion 30, and then being welded.

In such a metal tube 20, as shown in FIG. 4A, when a width of the metal plate MP is larger than an outer peripheral length of the laminate L1, an overlapping portion LP where the wrapped metal plate MP overlaps is present. The welding is performed at a location on the overlapping portion LP that is easily accessed by a welding machine. In this case, if the metal plate MP is sufficiently thick, the insulator 12 is less likely to be damaged due to the presence of the metal plate MP entering a lower side, but if the metal plate MP is thin, there is a possibility that a hole is formed during the welding or burrs B during the welding penetrates the metal plate MP on the lower side to damage the insulator 12. However, since the shielded solid electric wire 2 according to the second embodiment includes the inclusion 30 on an inner side of the metal tube 20, the possibility that the insulator 12 is damaged by heat or the like during the welding or the burrs B can be reduced.

Further, as shown in FIG. 4B, when the width of the metal plate MP substantially coincides with the outer peripheral length of the laminate L1, the overlapping portion LP of the metal plate MP is not present, and end portions E of the metal plate MP get into a state where the facing end portions E are in contact. In this case, the welding is performed between the end portions E of the metal plate MP in the contact state. That is, in the example shown in FIG. 4B, when the metal plate MP entering the lower side is not present, and the inclusion 30 is not provided, the insulator 12 is likely to be damaged during the welding. However, when the inclusion 30 is provided, the insulator 12 can also be less likely to be damaged during the welding. Further, the possibility that the insulator 12 is damaged by the burrs B after the welding can be reduced.

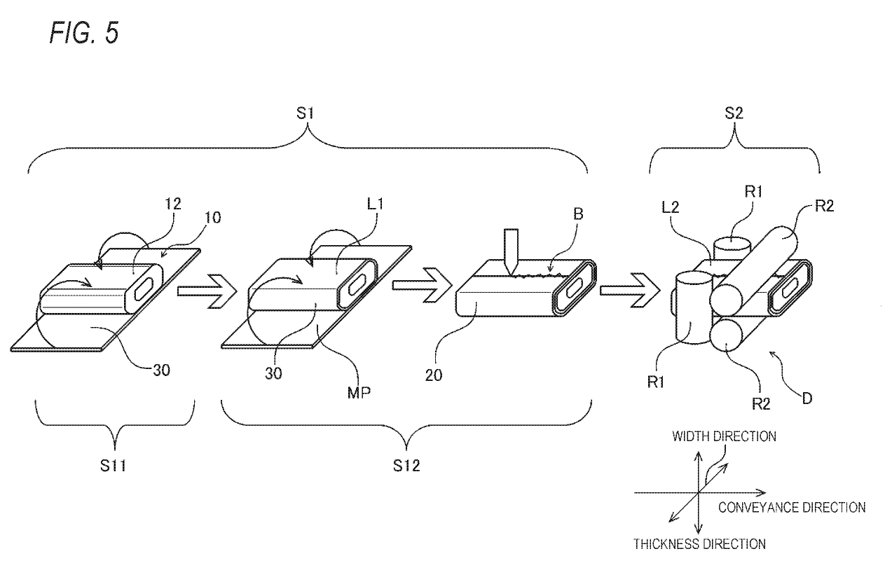

FIG. 5 is a process chart showing the method for manufacturing the shielded solid electric wire 2 according to the second embodiment. As shown in FIG. 5, the shielded solid electric wire 2 according to the second embodiment is manufactured through the laminating step S1 and the compression step S2.

In the laminating step S1, the first laminating step S11 is performed as in the first embodiment. Thereafter, in the second laminating step S12, the metal plate MP is wrapped around and welded to the laminate L1. First, in the second laminating step S12, the metal plate MP is longitudinally wrapped to the laminate L1. At this time, the metal plate MP is provided to have the overlapping portion LP shown in FIG. 4A or to get to the contact state shown in FIG. 4B.

Next, the welding is performed. At this time, since the inclusion 30 is provided on the outer periphery of the solid electric wire 10, the insulator 12 is less likely to be damaged during the welding. Further, the insulator 12 is also less likely to be damaged by the burrs B after the welding. Thereafter, the compression step S2 is performed as in the first embodiment to manufacture the shielded solid electric wire 2.

In this way, according to the shielded solid electric wire 2 and the manufacturing method therefor according to the second embodiment, the inclusion 30 in which a material having a friction coefficient smaller than that of the insulator 12 is formed in the outermost layer is provided on the outer periphery of the solid electric wire 10. Therefore, the inclusion 30 protects the insulator 12 from sparks and heat generated during the welding of the metal plate MP. Therefore, the necessity of performing welding while avoiding the insulator 12 from being damaged by the sparks or the heat, as when the inclusion 30 is not present, is reduced. Therefore, it is possible to provide the shielded solid electric wire 2 and the manufacturing method therefor capable of improving manufacturability.

According to the shielded solid electric wire 2 of the second embodiment, the insulator 12 can also be less likely to be damaged by the burrs B during the welding.

Further, according to the shielded solid electric wire 2 of the second embodiment, when the inclusion 30 is formed to include a material having a Young's modulus lower than that of the insulator 12, elasticity of the inclusion 30 can be used to reduce stress of the solid core conductor made of a conductive metal applied to the insulator 12 during bending of the shielded solid electric wire 2.

Further, when the inclusion 30 is formed to include a material having a heat-resistant temperature of 550°C or higher, even if the insulator 12 is damaged or melted, a short circuit between the solid core conductor 11 and the metal tube 20 can be easily prevented by the inclusion 30.

Although the present disclosure is described above based on the embodiments, the present disclosure is not limited to the embodiments described above; modifications may be made without departing from the gist of the present disclosure, and a publicly known or well-known technique may be combined.

For example, in the above embodiments, the inclusion 30 may be a sheet member having a multilayer structure including a conductive metal layer and an insulating resin film. In this case, by providing the metal layer inward of the resin film, the solid electric wire 10 can exhibit a shielding function of two layers including the metal layer and the metal tube 20, and a shielding performance can be improved by multiple reflections. In this case, the resin film may be made of a material having a friction coefficient smaller than that of the insulator 12, or a layer of the material may be formed further outward of the resin film.

In the above embodiments, the inclusion 30 is wrapped on the solid electric wire 10, but is not particularly limited thereto, and may be formed in a tubular shape in advance and provided on the solid electric wire 10 by inserting the solid electric wire 10.

In the above embodiments, the solid core conductor 11 is implemented by a busbar that is a flat metal plate, but is not particularly limited thereto, and may have another shape, such as a cylindrical shape having a circular cross-section. In this case, the solid core conductor 11 also preferably has a cross-sectional area of 3 mm² or more and 300 mm² or less, more preferably 10 mm² or more, and still more preferably 100 mm² or more. Further, when the solid core conductor 11 is formed to have a circular cross-section by a set of a plurality of metal members, the cross-sectional areas of the metal members preferably satisfy the above condition. Further, when the solid core conductor 11 has a circular cross-section or the like, the compression step S2 is performed inward from around according to the shape.

What is claimed is:

1. A shielded solid electric wire comprising:
a solid electric wire including a solid core conductor made of a conductive metal and an insulator covering the solid core conductor;
a conductive metal tube provided around the solid electric wire; and
an inclusion provided between the solid electric wire and the metal tube, an outermost layer of the inclusion on a metal tube side being made of a material having a friction coefficient smaller than that of the insulator.

2. The shielded solid electric wire according to claim 1, wherein
the inclusion is formed to include a material having a Young's modulus lower than that of the insulator.

3. The shielded solid electric wire according to claim 1, wherein
the inclusion is formed to include a material having a heat-resistant temperature of 550°C or higher.

4. The shielded solid electric wire according to claim 1, wherein
the inclusion is a sheet member having a multilayer structure including a conductive metal layer and an insulating resin film, and the metal layer is disposed inward of the resin film.

5. A method for manufacturing a shielded solid electric wire, the method comprising:
forming a laminated body by providing, on an outer periphery of a solid electric wire including a solid core conductor made of a conductive metal and an insulator covering the solid core conductor, an inclusion formed to include a material having a friction coefficient smaller than that of the insulator such that the material serves as an outermost layer, and providing a conductive metal tube on an outer periphery of the inclusion; and
compressing the formed laminated body inward from around the solid core conductor.
